(19) United States
(12) Patent Application Publication
(10) Pub. No.: US 2005/0038719 A1
(43) Pub. Date: Feb. 17, 2005

(54) System and method for suggesting goods and services based on inventory information

(76) Inventors: Miranda B. Young, Franconia, NH (US); Gary G. Young JR., Franconia, NH (US)

Correspondence Address: Peter A. Nieves;Hayes Soloway PC, 175 Canal Street, Manchester, NH, 03101, US

(21) Appl. No.: 10/914,883

(22) Filed: Aug. 10, 2004

Related U.S. Application Data
(60) Provisional application No. 60/494,638, filed on Aug. 12, 2003.

(51) Int. Cl. G06F 17/60

(52) U.S. Cl. 705/28

(57) ABSTRACT

The present invention is directed to a system and a method for suggesting information, to assist a user accomplish a planned activity. The system includes a memory having software stored therein, and a processor for performing steps defined by said memory, where the steps include: determining what items are to be pushed from a store; determining if items that are to be pushed from the store are physically located within the store; determining what items are not to be pushed from the store and are physically located within the store; and providing the user with a list of options, where the list of options includes an item from either the items that are to be pushed from the store, which are physically located within the store, or the items that are not to be pushed from the store, which are physically located within the store.

### CROSS-REFERENCE TO RELATED APPLICATION

This application claims the benefit of U.S. Provisional Patent Application Ser. No. 60/494,638, filed on Aug. 12, 2003, and entitled “System and Method for Suggesting Goods and Services,” which is incorporated by reference herein in its entirety.

### FIELD OF THE INVENTION

The present invention is generally related to the field of providing information for planning activities and, more particularly, to a system and method for providing information for planning a task based on a recommendation of goods and/or services.

### BACKGROUND OF THE INVENTION

Currently, there is a need to perform more and more complicated tasks in a limited amount of time. At the same time, one needs to have substantial information to make a good effort to perform complicated tasks. A poor effort may be defined as repeating the complicated tasks, thereby causing an even more acute shortage of time. For a typical consumer, there is a constant need to plan most shopping in advance, without enough time for much thought or discussion with friends or family members or qualified persons. On the other hand, the sheer range of available merchandise makes shopping daunting in many ways if a shopper enters the store with little preparation or information regarding the place being shopped. For example, often a consumer enters a store with just the name of a meal that is to be prepared in a short period of time, or with a home or automotive repair project on hand without information on how to complete the repair project or what materials are required. In such a situation, the consumer is generally in need of a large amount of planning information or a recommendation from a source of knowledge and/or expertise to carry out the activities quickly and successfully.

In addition to the issues of inadequate planning or lack of information, the consumer also faces paying higher prices for goods or services if he is unaware of available specials, discounts, or coupons applicable to the items being purchased. Similar to the problems mentioned above, such issues generally arise due to a shortage of time for the consumer and an increasingly sophisticated shopping environment. Most modern businesses are adopting very complex inventory control systems that result in an almost real-time inventory database. This permits a business to respond to supply and demand in an aggressive manner, thereby offering coupons to promote discounts and encourage the sale of slow-moving or high profit-margin goods and services. If the consumer is not aware of available coupons or items on sale, parties on both sides of the transaction stand to lose. In addition, the business does not obtain the full benefit of the existing inventory control system, and the purchaser is also prevented from saving his time and money in the absence of enough knowledge to carry out his shopping activity.

A method and apparatus exists for the generation of a shopping list based on national brands and store brands. The apparatus contains a terminal, for use by a customer, typically located in a store or a supermarket. The apparatus is primarily targeted to help a consumer generate a shopping list for a recipe he selects. Unfortunately, the consumer can only select recipes from the available choices. The apparatus does not accept an input from the customer regarding his own historical preferences for special dishes or meals, and there is no way for the consumer to know whether items in the generated shopping list are carried within the store.

A number of similar solutions have been created to address these problems. One method helps selection of ordering dishes or entrees in a restaurant when a customer prefers, or seeks to avoid, certain ingredients. Also, a device to manage a kitchen is presently available, where the device assists with a recipe, cooking time, monitoring, and reporting on the kitchen status. Systems and methods for delivering purchasing incentives through computer networks are also available. There is also an automatic maid that can keep track of household inventory and can order additional supplies. However, these methods and devices have the limitations of not permitting an individual to obtain a recommendation or recipe for a dish or a meal that he plans to prepare, or determine if the recipe ingredients are readily available at a local store.

Systems and methods are also presently available for household grocery management, which contain a computer system and a bar code scanner for managing groceries within a household. When using the system, a user scans an item into the computer system using the scanner. If the item is a newly purchased item, the item is added to a present grocery inventory, and if the item has been used, the item is subtracted from the present grocery inventory. The system also has the ability to add items to a shopping list based on a selected recipe. If the recipe selected has an item that is not presently in inventory, the item is added to the shopping list.

However, as described earlier, the above systems and methods have many limitations. There is little help for a user requiring information on a meal or a dish that he wants to make. In addition, there is no interaction with the business or the store to base a recommendation on immediate availability.

Thus, a heretofore unaddressed need exists in the industry to address the aforementioned deficiencies and inadequacies.

### SUMMARY OF THE INVENTION

Embodiments of the present invention provide systems and methods for suggesting, or recommending, information to a user based on an inventory database.

Briefly described, in architecture, one embodiment of the system, among others, can be implemented as follows. The system includes a memory having software stored therein, and a processor for performing steps defined by said memory, where the steps include: determining what items are to be pushed from a store; determining if items that are to be pushed from the store are physically located within the store; determining what items are not to be pushed from the store and are physically located within the store; and providing the user with a list of options, where the list of options includes an item from either the items that are to be pushed from the store, which are physically located within the store, or the items that are not to be pushed from the store, which are physically located within the store.

The present invention can also be viewed as providing methods for making suggestions to a user. In this regard, one embodiment of such a method, among others, can be broadly summarized by the following steps: determining what items are to be pushed from a store; determining if items that are to be pushed from the store are physically located within the store; determining what items are not to be pushed from the store and are physically located within the store; and providing the user with a list of options, where the list of options includes an item from either the items that are to be pushed from the store, which are physically located within the store, or the items that are not to be pushed from the store, which are physically located within the store.

Other systems, methods, and advantages of the present invention will be or will become apparent to one having ordinary skill in the art upon examination of the following drawings and detailed description. It is intended that all such additional systems, methods, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a system diagram illustrating a general-purpose computer architecture that can implement the information suggestion system, in accordance with the first exemplary embodiment of the invention.

FIG. 2A is an exemplary screen view of a meal creation top-level menu that may be provided by the system of FIG. 1.

FIG. 2B is an exemplary screen view of a main course selection menu that may be provided by the system of FIG. 1.

FIG. 2C is an exemplary screen view of a main course meat selection menu that may be provided by the system of FIG. 1.

FIG. 3A is an exemplary screen view of a main course chicken entrée selection menu that may be provided by the system of FIG. 1.

FIG. 3B is an exemplary screen view of a chicken entrée suggestion display that may be provided by the system of FIG. 1.

FIG. 3C is an exemplary screen view of a display for selecting various suggested side dishes, beverages, and desserts to create a complete meal that may be provided by the system of FIG. 1.

FIG. 4A is an exemplary screen view of a meal choice display that may be provided by the system of FIG. 1.

FIG. 4B is an exemplary screen view of a shopping list display that may be provided by the system of FIG. 1.

FIG. 4C is an exemplary screen view of a recipe display that may be provided by the system of FIG. 1.

FIG. 5 is a block diagram illustrating different databases accessed due to functionality defined by the software stored within the system of FIG. 1.

FIG. 6 is a flow chart illustrating steps taken by the information suggestion system of FIG. 1, in suggesting information to a user if a user identification is utilized.

FIG. 7 is a flow chart illustrating an example of options provided by the information suggestion system of FIG. 1, during creation of a meal.

FIG. 8 is a flow chart illustrating steps taken by the information suggestion system of FIG. 1, in suggesting information to a user if a user identification is not utilized.

FIG. 9 is a flow chart illustrating an example of user interaction with the information suggestion system of FIG. 1, in accordance with the example provided by FIG. 7

FIG. 10A is an exemplary screen view of a top-level project selection menu, in accordance with a second exemplary embodiment of the present invention, where the system is utilized in home improvement.

FIG. 10B is an exemplary screen view of a kitchen project selection menu, in accordance with the second exemplary embodiment of the present invention.

FIG. 10C is an exemplary screen view of a kitchen remodel choice display, in accordance with the second exemplary embodiment of the present invention.

### DETAILED DESCRIPTION

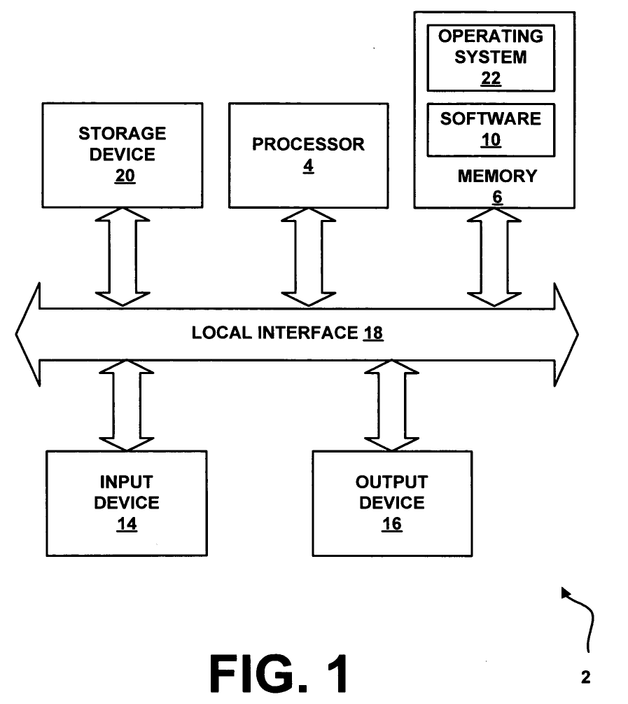

The present invention is an information suggestion system 2, as shown in FIG. 1. The information suggestion system 2 is designed for suggesting information to a user, based on choices made by the user, using a push database and an inventory database of a store, as well as other databases described herein. The system 2 is designed for customer use at a business that provides goods or services to customers who may require instructions, directions, or recipes to complete a variety of planned activities.

The information suggestion system 2 can be implemented in software, firmware, hardware, or a combination thereof. In a first exemplary embodiment, a portion of the information suggestion system 2 is implemented in software, as an executable program, and is executed by a special or general-purpose digital computer, such as a personal computer, workstation, minicomputer, or mainframe computer. The first exemplary embodiment of a general-purpose computer architecture that can implement the information suggestion system 2 is shown in FIG. 1.

Generally, in terms of hardware architecture, as shown in FIG. 1, the computer of the information suggestion system 2 includes a processor 4, a memory 6 capable of enabling execution of functions defined by software 10, one or more input devices 14 and output devices 16, or peripherals, and a storage device 20, that are communicatively coupled via a local interface 18. It should be noted that the storage device 20 may have numerous databases therein, as is described in detail below. The local interface 18 can be, but is not limited to, one or more buses or other wired or wireless connections, as is well known in the art. The local interface 18 may have additional elements, which are omitted for simplicity, such as controllers, buffers (caches), drivers, repeaters, and receivers, to enable communications. Further, the local interface 18 may include address, control, and/or data connections to enable appropriate communications among the aforementioned components.

The processor 4 is a hardware device for executing software, particularly the software 10 stored in the memory 6. The processor 4 can be any custom-made or commercially available processor, a central processing unit (CPU), an auxiliary processor among several processors associated with the computer of the information suggestion system 2, a semiconductor-based microprocessor (in the form of a microchip or chip set), a macroprocessor, or generally any device for executing software instructions.

The memory 6 can include any one or combination of volatile memory elements (e.g., random access memory (RAM, such as DRAM, SRAM, SDRAM, etc.)) and nonvolatile memory elements (e.g., ROM, hard drive, tape, CD-ROM, etc.). Moreover, the memory 6 may incorporate electronic, magnetic, optical, and/or other types of storage media. Note that the memory 6 can have a distributed architecture, where various components are situated remotely from one another, but can be accessed by the processor 4.

The software 10 may include one or more separate programs, each of which comprises an ordered listing of executable instructions for implementing logical functions. In the first exemplary embodiment of FIG. 1, the software 10 defines functionality performed by the information suggestion system 2 and an operating system 22 (OS).

The operating system 22 essentially controls the execution of other computer programs, such as the software 10 of the information suggestion system 2, and provides scheduling, input-output control, file and data management, memory management, and communication control and related services.

The software 10 of the information suggestion system 2 is a source program, executable program (object code), script, or any other entity comprising a set of instructions to be performed. The source program may be translated via a compiler, assembler, interpreter, or the like, which may or may not be included within the memory 6, so as to operate properly in connection with the operating system 22. Furthermore, the software 10 of the information suggestion system 2 can be written as (a) an object-oriented programming language, which has classes of data and methods, or (b) a procedure programming language, which has routines, subroutines, and/or functions.

The input devices 14 may include, for example, but not limited to, a keyboard, mouse, scanner, or microphone. The input devices 14 may be located in a kiosk, for example, near the entrance to a store or inside a store. Furthermore, the output devices 16 may include, for example, but not limited to, a printer or display. Finally, the input devices 14 and output devices 16 may further include devices that communicate as both inputs and outputs, for instance but not limited to, a modulator/demodulator (e.g., modem, for accessing another device, system, or network), a radio frequency (RF) or other transceiver, a telephonic interface, a bridge, a router, or a touchscreen.

If the information suggestion system 2 includes a PC, workstation, or the like, the software 10 in the memory 6 may further include a basic input output system (BIOS). The BIOS is a set of essential software routines that initialize and test hardware at startup, start the operating system 22, and support the transfer of data among the hardware devices. The BIOS is stored in ROM so that the BIOS can be executed when the software 10 of the information suggestion system 2 is activated.

When the information suggestion system 2 is in operation, the processor 4 is configured to execute the software 10 stored within the memory 6, to communicate data to and from the memory 6, and to generally control operations of the information suggestion system 2 under the control of the software 10. The information suggestion system 2 and the operating system 22, in whole or in part, but typically the latter, are read by the processor 4, generally buffered within the processor 4, and executed.

The information suggestion system 2 also contains the storage device 20 for storing the various databases described herein. It should be noted that the storage device 20 is utilized in the present invention to store data necessary to provide menus and information necessary for screen views described herein. As an example, files associated with images, and titles displayed on screen views, including names on buttons, colors, etc., are stored within the storage device 20. It should also be noted that, in accordance with alternative embodiments of the invention, certain databases may be located external from the storage device 20, where information stored within an external database is transferred to the information suggestion system 2 for use by the system 2.

The storage device 20 may be a computer readable medium that is removable, stationary, or stationary with a removable computer readable medium located therein. The storage device 20 may be an electronic, magnetic, optical, or other physical device or arrangement that can contain or store video and/or a computer program, for use by or in connection with the computer of the information suggestion system 2. Specifically, as is described in detail below, the storage device 20 has multiple databases located therein for use by the information suggestion system, as is described in detail below.

In the context of this invention, a computer readable medium is an electronic, magnetic, optical, or other physical device or arrangement that can contain or store a computer program for use by or in connection with a computer-related system or method. The information suggestion system 2 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this invention, a “computer-readable medium” can be any arrangement that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples of the computer-readable medium would include, but are not limited to, the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), and an optical disk such as a portable compact disc read-only memory (CD-ROM) (optical). The computer-readable medium also could be paper or another suitable medium upon which the program is printed, as the program can be electronically captured via, for instance, optical scanning of the paper or other medium, compiled, interpreted, or otherwise processed in a suitable manner if necessary, and stored in a computer memory.

Moreover, each of the functional components of the present invention may be embodied as one or more distributed computer program processes running on one or more conventional general-purpose computers networked together by conventional networking hardware and software. Each of these functional components may be embodied by running distributed computer program processes on networked computer systems (e.g., comprising mainframe and/or symmetrically or massively parallel computing systems) including appropriate mass storage, networking, and other hardware and software for permitting these functional components to achieve the stated function. These computer systems may be geographically distributed and connected together via appropriate wide and local-area network hardware and software. The present invention may alternatively use the public Internet and Internet-compatible HTTP and UDP protocols for the network interconnections described herein or other networks. The communications media described herein (generally referred to using the generic term “network”) may be a wired or wireless network, or a combination thereof.

Alternatively, the aforesaid functional components may be embodied by a plurality of separate computer processes stored on microprocessor-based personal computers networked together via conventional networking hardware and software, and including such other additional conventional hardware and software as is necessary to permit these functional components to achieve the stated functionalities. Such personal computers may be unable to run full-scale relational database engines of the types presented above. Therefore, in this alternative configuration, a non-relational flat file “table” may be included in at least one of the networked personal computers to represent at least portions of data stored by a system consistent with the present invention. The aforesaid functional components of a system consistent with the present invention may also comprise a combination of the above two configurations (e.g., by computer program processes running on a combination of personal computers, mainframes, symmetric or parallel computer systems, and/or other appropriate hardware and software, networked together via appropriate wide-area and local-area network hardware and software).

Where the information suggestion system 2 is implemented in hardware only, the information suggestion system 2 can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the purposes of illustration, the first exemplary embodiment of the information suggestion system 2 is described with reference to recipe, or meal suggestion. However, implementation of the information suggestion system 2 is not limited to this example. The information suggestion system 2 may be used to suggest information other than recipes or planning cooking activities, such as, but not limited to, tools and supplies necessary for completing a home improvement project or automotive project.

In the first exemplary embodiment, the information suggestion system 2 is partly located in a kiosk that resembles an automatic teller machine. The system 2 has a touch screen video display terminal and a printer (i.e., input device 14 and output device 16). The kiosk may be placed near the entrance to a grocery store or anywhere else in the store. Customers may input information or selections into the information suggestion system 2 using a touch screen, keyboard, mouse, or any other input device 14 known to those having ordinary skill in the art. The information suggestion system 2 may also include an infrared transmitter that allows stored recipes, menus, store maps, and shopping lists to be downloaded to a personal digital assistant (PDA) or other similar device. The information suggestion system 2 may communicate with a computer located in a remote location by wired or wireless communication. Wireless communication allows flexibility to move the information suggestion system 2 around the store to many different locations. The information suggestion system 2 allows a user to create entire meals including appetizers, side dishes, desserts, and beverages, and not just a single entrée or appetizer. The above-mentioned is described in detail below.

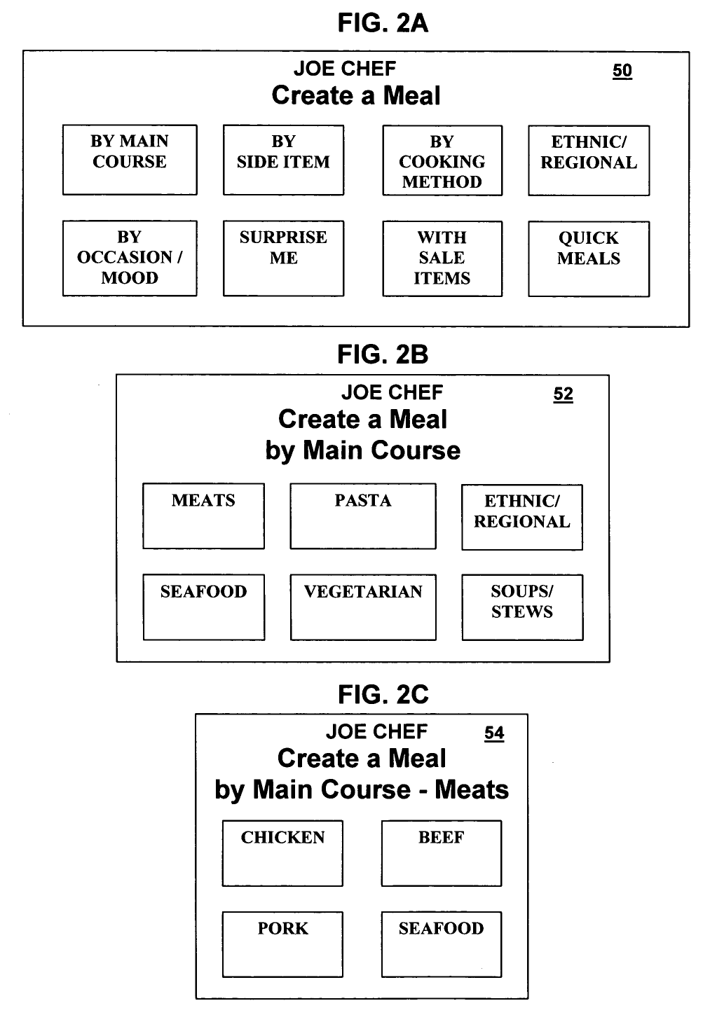

FIGS. 2-4 illustrate a series of exemplary screen views used in the information suggestion system 2, to allow the user to plan a menu for a meal. The accessing of information for the screen views may be defined by the software 10 (FIG. 1), although, as mentioned above, files defining titles and colors, among other things, are stored within the storage device 20.

FIG. 2A shows the first screen view 50 encountered by the user when using the information suggestion system 2, in accordance with the first exemplary embodiment. This screen view 50 allows the user to create a meal by a variety of methods. The user can create a meal by selecting a main course, a side item, or a cooking method; by dietary concerns; by type of occasion for which food is being prepared; by mood of the chef; by meals using sale or discounted items, ethnic, or regional food; by the amount of preparation time required; or, any other system of categorizing meal choices. Also, at any point during the process, the user can, alternatively, directly input a category of food that he/she wants to cook by using the keyboard or touch screen. Information associated with the preparation of the category of food may be stored within the storage device 20, so that when the user enters the category of food via the keyboard or touch screen, a meal associated with that category of food, stored within the storage device 20, may be provided to the user via display on the touch screen. Finally, the user can have the information suggestion system 2 suggest a complete meal or an item without the user inputting any preferences, using a “surprise me” option. For this option, the software 10 (FIG. 1) may cause random selection from a series of complete meals, descriptions of which may be stored within the storage device 20.

FIG. 2B is an example of a new screen view illustrating choices available to the user if he chooses to create a meal by main course. As is shown by FIG. 2B, if the user selects to create a meal by main course, the new screen view 52 provides the user with a series of choices of types of food to select from. As an example, the new screen view 52 of FIG. 2B illustrates options for “meats, “pasta,” “Ethnic/Regional” food, “seafood,” “vegetarian,” and “soups/stews.” Of course, other choices may be provided.

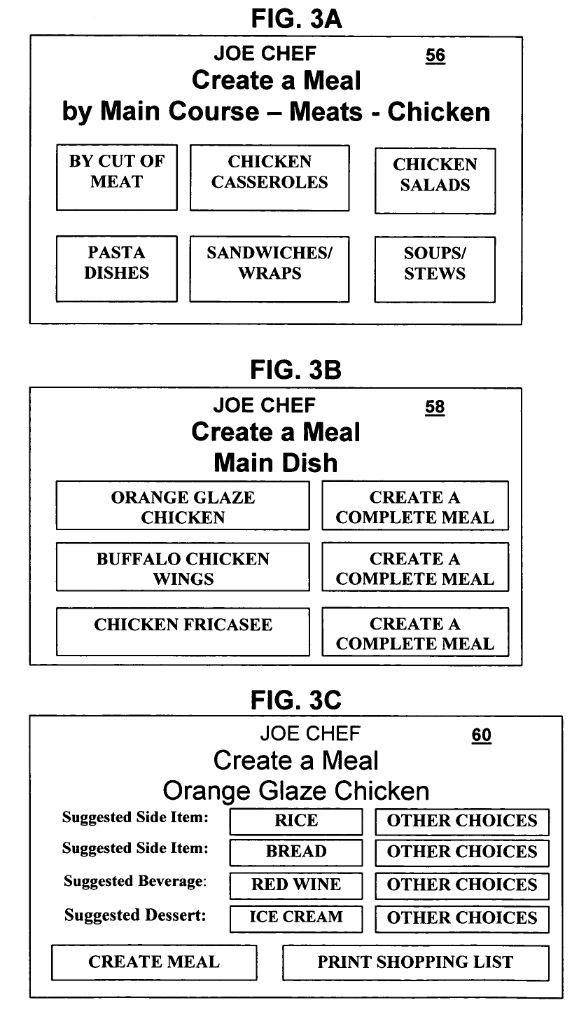

FIGS. 2C and 3A are two exemplary screen views 54, 56 illustrating what may be displayed when the user selects a meal based on having a meat as the main course and choosing chicken as the main entrée, respectively. If the user indicates that the main course of the meal they are planning is a chicken dish, such as by selecting the option “By Cut of Meat,” shown in FIG. 3A, the information suggestion system 2 may suggest various entrées, as shown by the screen view 58 of FIG. 3B. Also shown in the screen view 58 of FIG. 3B is an option to create a complete meal to compliment one of the chicken dishes that may be selected. Specifically, each option for a chicken dish may have a separate option for the user to create a complete meal with the selected chicken dish.

If the user selects to create a complete meal, the information suggestion system 2 may present a screen view 58 that suggests various appetizers, side dishes, beverages, and/or desserts to create a complete meal, as shown in the screen view 60 of FIG. 3C. The user can either accept these other items or have the information suggestion system 2 present other choices for the various complementary items by, for example, selecting an “Other Choices” option.

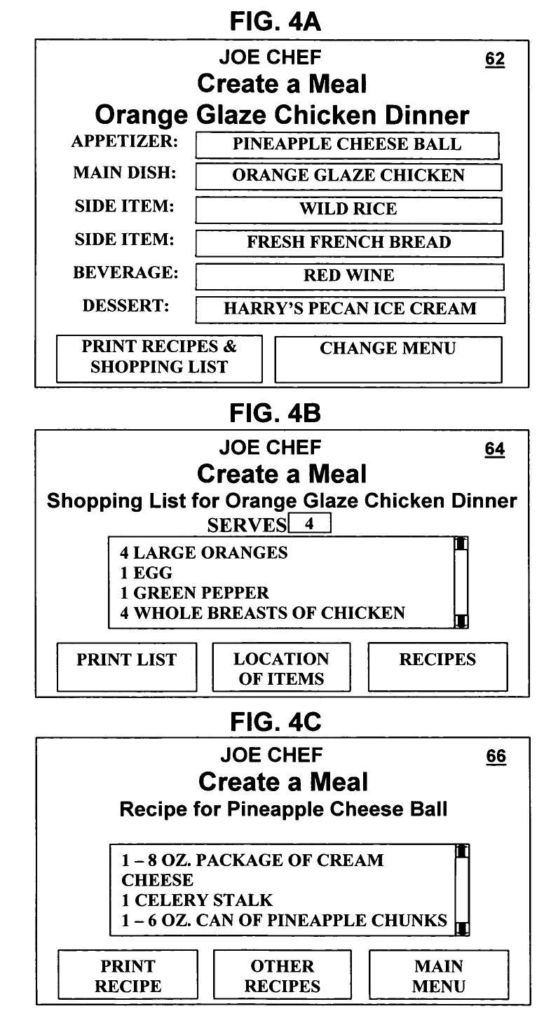

When the user finalizes his or her menu, the user may select a “create meal” option. The user may then be presented with a summary screen 62, as shown in FIG. 4A, which details the previously selected meal choices. In addition, the user may wish to create a shopping list for the items necessary to create the completed meal. To obtain a shopping list, the user may select a “print shopping list” option from the screen view of FIG. 3C, or from the summary screen 62 of FIG. 4A. FIG. 4B provides a screen view 64 providing an example of a displayed shopping list.

It should be noted that the screen view 64 of FIG. 4B, having the shopping list therein, also provides options to print the shopping list, find the location of items within the store, or to display the recipe associated with the created meal. If the user selects to find the location of items within the store, the user may be provided with a map of the store, via the screen, where location of the items are highlighted, or lighted. Alternatively, simply a list of the locations of the items may be provided. Of course, the locations may also be printed or downloaded. If the user selects to view the recipe, a recipe screen view 66 is provided to the user having the recipe therein and options to print the recipe, view other recipes or return to the main menu of FIG. 2A. The user may also have an option to view nutritional facts about the planned meal.

The menu, recipe(s), and shopping list may be printed on paper, downloaded into a PDA, emailed to an email account, or otherwise provided or transmitted to the user. The above information regarding meal choices is stored within the storage device 20.

The software 10 allows a user to access the system 2 either anonymously or by identifying himself or herself. Generally, if the software 10 requires user identity information to formulate suggestions, the user first enters identity data via an input device 14, or utilizes an identification device that has such identity data stored therein. If the identification device is utilized, the system 2 may read the identification device via use of a user interaction mechanism, one type of input device 14, that is capable of reading the identification device, specifically, the user interaction mechanism is an input device 14 located within the system 2.

The identification device may be a user loyalty card, a rewards card, or a credit card. In addition, the identity data may be an identification number, a set of login ID and password, or other data or arrangement of providing identification. It should be noted that while the user interaction mechanism, or input device 14, is defined as a portion of the system 2, the user interaction mechanism 14 may be located remote from the system 2 in other embodiments. In such embodiments, the user interaction mechanism 14 may require a remote communication technology, such as, but not limited to, a wireless transmitter, for which a wireless receiver would be located within the system 2.

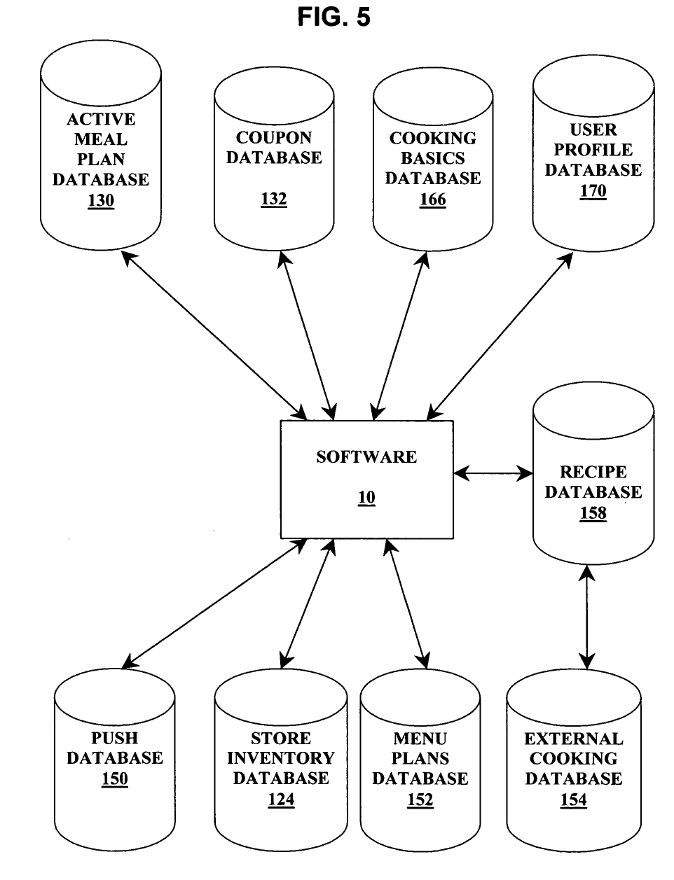

FIG. 5 is a block diagram illustrating databases located within the storage device 20, which are accessed in accordance with instructions from the software 10. It should be noted that the use of separate databases is merely provided as an example of implementation of the present system 2. Alternatively, certain data may be located separate from the storage device 20, or combined in a fashion not characteristic of a single database.

The software 10 employs an active meal plan database 130, a user profile database 170, a recipe database 158, a menu plans database 152, a store inventory database 124, and a push database 150, to determine what items or meals to suggest to the user. A store may prefer the sale of a slow-selling or a high profit-margin item. Items the store is particularly motivated to sell are defined as push items and the database of such items is defined as the push database 150.

The active meal plan database 130 contains details regarding the meal planned by the user. Specifically, the active meal plan database 130 contains a list of the items currently on the menu, the recipes of the items, and a shopping list of the ingredients needed for the active meal plan. The user profile database 170 contains information about the active user of the system 2. The user profile database 170 may contain biographical information about the user, including age, gender, familial status, shopping history, and other user information that may be helpful in choosing a meal. The user profile database 170 also could contain information about the tastes or other preferences of the user based on meals previously planned using the system 2, such as items or entrees preferred and items or entrees rejected.

The recipe database 158 contains different recipes using various items sold in the grocery store. The recipes may include brand names of items. It should be noted that the recipe database 158 can be updated or enlarged using external cooking databases 154, such as Internet cooking sites and cooking magazines. Alternatively, the recipe database 158 may contain items not sold in the grocery store, however, it is beneficial to display that such items are not available in the store, if they are used in creating a meal.

The menu plans database 152 contains pre-planned meals and various entrees, side dishes, beverages and desserts, cross-referenced to other various entrees, side dishes, beverages and desserts that are compatible with that item. For example, vegetable yakisoba could be cross-referenced to miso soup, soybeans, and green tea. Hamburgers could be cross-referenced to French fries (or potatoes in general), beer, ice cream, and apple pie. The menu plans database 152 can also contain information on condiments to be served with or on the items. For example, the listing for hamburgers could include the list of condiments that can be put on a hamburger, such as catsup, mustard, pickles, lettuce, tomatoes, bacon, chili, cheese, and onions.

The store inventory database 124 contains a listing of the inventory of the grocery store and the location of the items within the store. A store may maintain more than one version of the store inventory database 124. One version may be intended for the user and another version may be intended for internal use by store management. The store inventory database 124 may have the ability to obtain updates as a result of a purchase, or return, of an item by a user. Based on the intended application, the frequency of back up and the frequency of refreshing the store inventory database 124 may be implemented as required by the store. In order to protect proprietary information or similar information sensitive for business operations, the store may block or limit access by the user to the store inventory database 124, as appropriate. However, the system 2 may be implemented in a manner allowing the store management to access the system 2 through a login identification and a password. Use of a user login identification and password is described below.

It should be noted that the store inventory database 124 may be updated automatically via use of different technologies. As an example, the store inventory database 124 may be updated by check out registers in a store, where the purchase of an item, via the check out register, automatically reduces the count of that item within the store inventory database 124. In addition, the return of an item in a store, as an example, via a register at a customer service center, may increase the count of that item within the store inventory database 124. Alternatively, devices may be utilized within the store to automatically keep count of the number of a specific item within a specific location of the store. As an example, radio frequency identification (RFID) technology may be utilized to detect when an item is removed from a specific location, or from the store itself, thereby keeping an accurate count of the number of the item within the store. It should also be noted that the store inventory database 124 may be located external from the information suggestion system 2. Specifically, the store inventory database 124 may be located on an external storage device that is internal to the store itself, where the information suggestion system 2 is capable of accessing the external storage device either through a direct wired connection or through a wireless connection.

Generally, a coupon database 132, the user profile database 170, the push database 150, and the store inventory database 124 may be maintained by the store. However, a cooking basics database 166, the recipe database 158, the external cooking database 154, and the menu plans database 152 may be maintained by the information suggestion system 2.

The coupon database 132 contains coupons that the store might want to offer to the user of the information suggestion system 2. The coupon database 132 also interacts with the store inventory database 124. In addition, the cooking basics database 166 contains cooking instructions, such as, but not limited to, cooking temperatures and time required for achieving different degrees of doneness.

The push database 150 contains a list of items that the supermarket wants to push. Specifically, grocery stores may want to encourage the sale of a certain item for many reasons, including to introduce the item to consumers, to sell overstocked or clearance items, or to sell items with a high profit margin. The push database 150 could be used as an effective way to encourage the sale of the items.

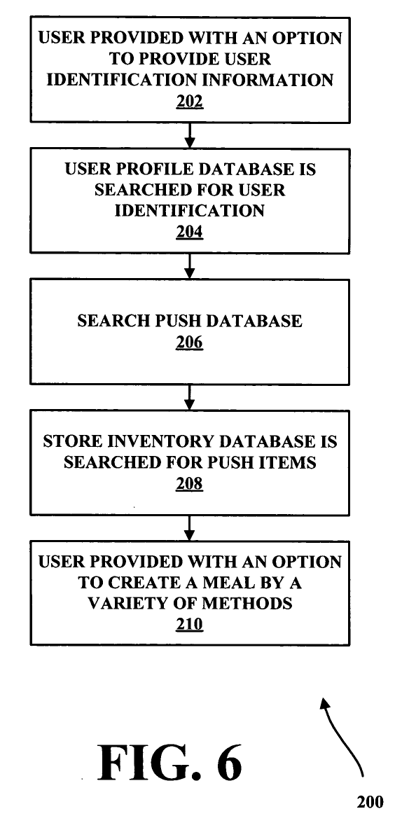

Various methods using these databases may be employed by the information suggestion system 2 to determine what to offer as a suggestion. The flow chart of FIG. 6 shows the architecture, functionality, and operation of a possible implementation of the embodiment of the system 2 and interaction between databases, as illustrated by FIG. 5.

The exemplary information suggestion system 2 may also provide the ability, within viewed recipes, for the user to click on or touch a cooking term that they do not understand in order to find out additional information regarding the term. For example, if the displayed recipe calls for meat to be braised, the user may click on, or touch, the term “braised” and instructions on how to properly braise the meat will appear on the screen. This information may be stored within the cooking basics database 166. The user may email, download, or print these instructions, which are stored within the cooking basics database 166.

The information suggestion system 2 may also assist a beginning or inexperienced chef with a cooking timeline to help the individual determine when to perform certain tasks related to cooking the meal. For example, the information suggestion system 2 can create a timeline illustrating to the new or inexperienced chef when to defrost the meat, put bread in the oven, and when to begin cooking vegetables, all based on the target meal time. The user may email, download, or print these instructions. Providing such a timeline may be an option displayed on the summary screen 62 (FIG. 4A, not shown).

Furthermore, if the information suggestion system 2 is connected to the Internet, certain cooking Web sites may be accessible to the user through the information suggestion system 2. The user may also have the ability to search through old issues of popular cooking magazines to find recipes, ideas for meals, etc.

FIG. 6 is a flow chart 200 illustrating steps taken by the information suggestion system 2 of FIG. 1, in suggesting information to a user if a user identification is utilized. Generally, a block in the figures explained represents a module, segment, or portion of code, which comprises one or more executable instructions for implementing the specified logical function(s). It should also be noted that in some alternative implementations, the functions noted in the blocks might occur out of the order noted in the figures. For example, two blocks shown in succession may be executed substantially concurrently or the blocks may sometimes be executed in the reverse order, depending upon the functionality involved.

As is shown by FIG. 6, the user may be provided with an option to provide user identification (block 202). If the information suggestion system 2 requires user identity information to formulate suggestions, the user first enters identity data via an input device 14 (FIG. 1), or utilizes an identification device that has such identity data stored therein. If the identification device is utilized, the information suggestion system 2 (FIG. 1) may read the identification device via use of a user interaction mechanism that is capable of reading the identification device.

If the user enters a user identification, the user profile database 170 (FIG. 5) is searched for the user identification (block 204). As is previously mentioned, the user profile database 170 (FIG. 5) has stored therein, not only user identifications, but also information about the active user identified by the user identification and items preferred and not preferred by the user. Information regarding the identified user, and/or the preferred items, is used to search the push database 150 (FIG. 5) (block 206). As is mentioned above, the push database 150 (FIG. 5) has stored therein a list of items that the store wishes to push, also regarded to herein as push items. If push items that match information about the active user, or push items that match the preferred items, are found in the push database 150 (FIG. 5), the store inventory database 124 (FIG. 5) is searched to determine if the push items are located within the store (block 208).

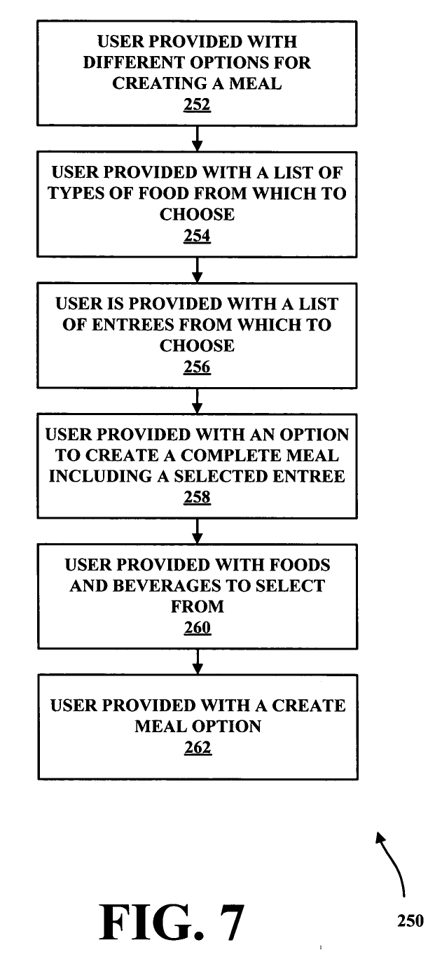

The user is then provided with a screen view allowing the user to create a meal by a variety of methods, as demonstration above (block 210). An example of options provided during creation of a meal is illustrated by FIG. 7. It should be noted that, if the push items are located within the store, the choices provided to the user, in response to user selections or specification, include the push items. In addition, the choices provided to the user do not include items not preferred by the user.

Another item that may influence the choices provided to the user includes coupons currently available by the store, which are stored within the coupons database 132 (FIG. 5). Specifically, push items, or regular items, having associated coupons may be provided to the user. Alternatively, the coupons database 132 (FIG. 5) may instead be used by the information suggestion system 2 after the user is provided with a meal, to provide the user with coupons associated with items within the meal. It should be noted that items with coupons described herein may alternatively be replaced by sale items.

As the user creates a meal, the active meal plan database 130 (FIG. 5) stores the current selections of the user within the database 130 (FIG. 5). The result of user selections is at least one meal, entrée, or recipe having push items that are available in the store. The at least one recipe may be provided by searching the recipe database 158 (FIG. 5) for items selected by the user, or searching for preferred items.

When providing meals to the user, an estimate of the amount of time, and the skill level, needed to create the associated meal, as well as the cost of a dish or a meal, may also be provided.

Resulting meals may be provided to the user in numerous manners. As an example, the resulting meals may be displayed on the touch screen, printed, verbalized by the information suggestion system 2, or downloaded to a device having a memory and a processor, such as a palm pilot.

FIG. 7 is a flow chart 250 illustrating an example of options provided during creation of a meal, as shown in FIGS. 2, 3, and 4. A user is provided with different options for creating a meal (block 252). As is previously mentioned above, the user can create a meal by selecting a main course, a side item, or a cooking method; by dietary concerns; by type of occasion for which food is being prepared; by mood of the chef; by meals using sale or discounted items, ethnic, or regional food; by the amount of preparation time required; by selecting a recipe publication, or, any other system of categorizing meal choices. Also, at any point during the process, the user can, alternatively, directly input a category of food that he/she wants to cook by using the keyboard or touch screen. Of course, other meal creating options may be provided.

The user is then provided with a list of types of food from which to choose (block 254). As an example, the screen view 52 of FIG. 2B illustrates options for “meats, “pasta,” “Ethnic/Regional” food, “seafood,” “vegetarian,” and “soups/stews.” Of course, other choices may be provided. As is shown by block 256, the user is then provided with a list of entrees from which to choose, where the entrees correspond to the type of food selected by the user. With each entree the user may also be provided with an option to create a complete meal including a selected entree (block 258).

If the user selects to create a complete meal, the user may be provided with foods, such as side items, appetizers, and desserts, and beverages to select from in order to create the complete meal (block 260). As an example, the user may be provided with various appetizers, side dishes, beverages, and/or desserts to create a complete meal. The user can either accept these other items or have the information suggestion system 2 present other choices for the various complementary items by, for example, selecting an “Other Choices” option.

The user is then provided with a “create meal” option, the selection of which provides the user with a summary of their selected meal choices (block 262). In addition, the user may be provided with an option to print a shopping list associated with the items in the created meal. Further, the user may be provided with an option to list locations of items within the store.

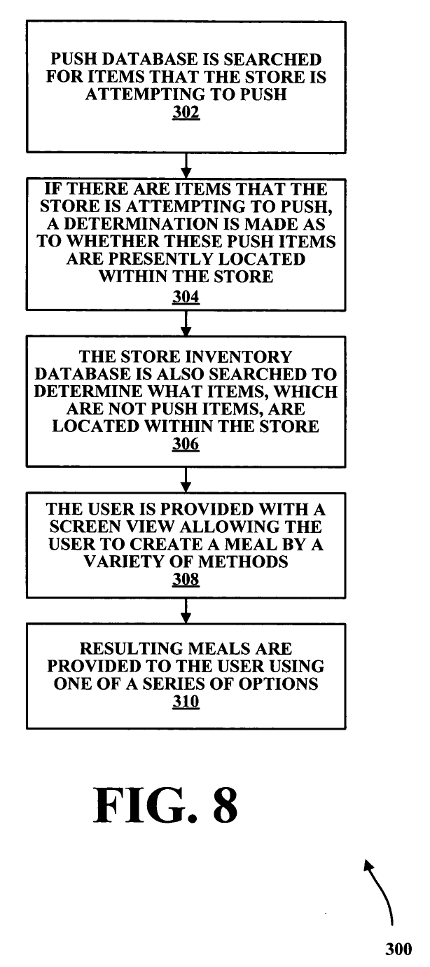

In accordance with an alternative embodiment of the invention, the user may not be asked to provide a user identification, or the user may simply bypass the option to enter the user identification. FIG. 8 is a flow chart 300 illustrating steps taken by the information suggestion system 2 of FIG. 1, in suggesting information, such as entrees and recipes, to a user if a user identification is not utilized.

The push database 150 (FIG. 5) is searched for items that the store is attempting to push, also referred to herein as push items (block 302). If there are items that the store is attempting to push, a determination is made as to whether these push items are presently located within the store (block 304) by searching the store inventory database 124 (FIG. 5). Whether there are push items or not, the store inventory database 124 (FIG. 5) is also searched to determine what items, which are not push items, are located within the store (block 306).

The user is provided with a screen view allowing the user to create a meal by a variety of methods, as demonstrated above (block 308). It should be noted that, if the push items are located within the store, the choices provided to the user, in response to user selections or specification, include the push items. In addition, the choices provided to the user include items that are not push items, however, which are located within the store. As an example, the choices provided to the user may include a meal having a main entrée and a series of side dishes. In such a situation, the recipe for the main entrée and the series of side dishes include push items located within the store and other items that are known to be located within the store.

Resulting meals are provided to the user using one of a series of options (block 310). As an example, the resulting meals may be displayed on the touch screen, printed, verbalized by the information suggestion system 2, or downloaded to a device having a memory and a processor, such as a palm pilot.

Another item that may influence the choices provided to the user includes coupons currently available by the store, which are stored within the coupons database 132 (FIG. 5). Specifically, push items, or regular items, having associated coupons, may be provided to the user. Alternatively, the coupons database 132 (FIG. 5) may instead be used by the information suggestion system 2 after the user is provided with a meal, to provide the user with coupons associated with items within the meal. It should be noted that items with coupons described herein may alternatively be replaced by sale items.

When providing items within meals to the user (i.e., side dishes, entrees, etc.), an estimate of the amount of time, and the skill level, needed to create the item of the associated meal, as well as the cost of a dish or a meal, may also be provided. In addition, a list or map of locations of items listed within the resulting menu may be provided to the user.

It should be noted that, since the store inventory database 124 (FIG. 5) is preferably updated in real time, the final menu provided to the user is an accurate accounting of items that the store wishes to push, as well as non-push items, where both the push items and non-push items are located within the store, and the items are requested by the user.

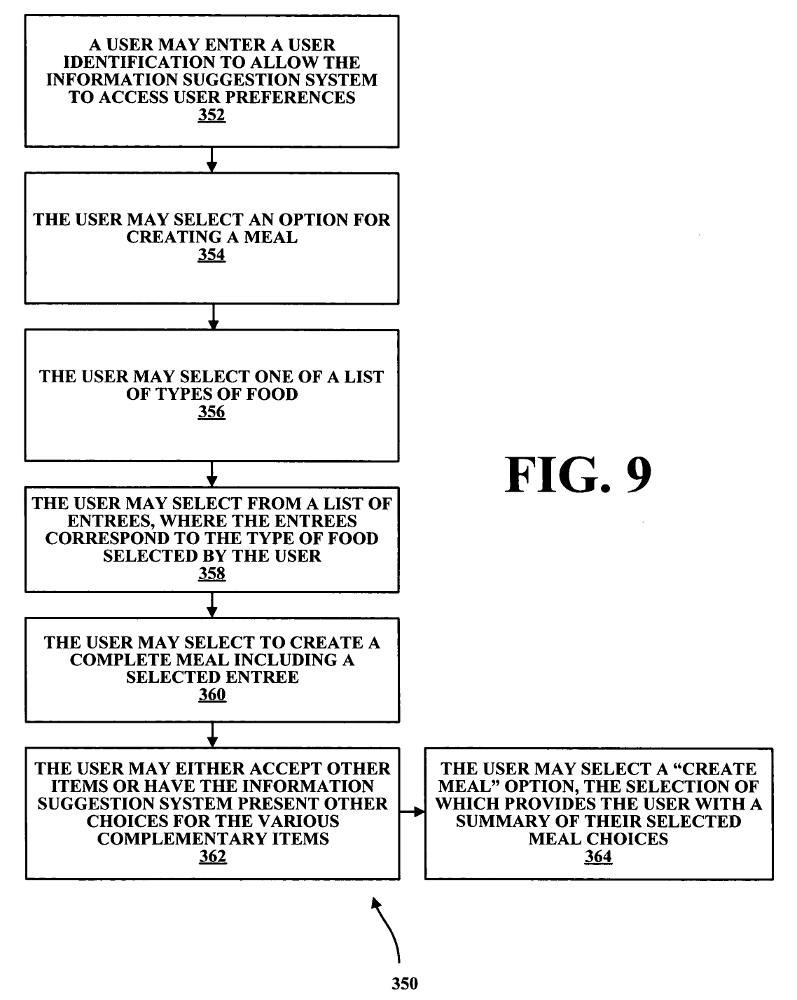

FIG. 9 is a flow chart 350 illustrating an example of user interaction with the information suggestion system 2 of FIG. 1, in accordance with the example provided by FIG. 7. It should be noted that communication with the information suggestion system 2 may be provided locally by the user, or remotely by the user via use of known local area network and wide area network technologies.

As is shown by block 352, a user may enter a user identification to allow the information suggestion system 2 to access user preferences, as is explained in detail above. Alternatively, the user may select to bypass entering a user identification, or the user may not be provided with an option to enter a user identification.

The user may select an option for creating a meal (block 354). As an example, the user can create a meal by selecting a main course, a side item, or a cooking method; by dietary concerns; by type of occasion for which food is being prepared; by mood of the chef; by meals using sale or discounted items, ethnic, or regional food; by the amount of preparation time required; or, any other system of categorizing meal choices. Also, at any point during the process, the user can, alternatively, directly input a category of food that he/she wants to cook by using the keyboard, touch screen, or any other input device. Of course, other meal creating options may be provided.

The user may select one of a list of types of food (block 356). As an example, the list of types of food that the user may select from may include, “meats, “pasta,” “Ethnic/Regional” food, “seafood,” “vegetarian,” and “soups/stews.” Of course, other choices may be provided. The user may then select from a list of entrees, where the entrees correspond to the type of food selected by the user (block 358). In addition, the user may select to create a complete meal including a selected entree (block 360).

If the user selects to create a complete meal, the user may be provided with foods and beverages to select from in order to create the complete meal. As an example, the user may be provided with various appetizers, side dishes, beverages, and/or desserts to create a complete meal. Therefore, the user may either accept the other items or have the information suggestion system 2 present other choices for the various complementary items by, for example, selecting an “Other Choices” option (block 362). Alternatively, the user may type the names of complimentary items into an input device 14 (FIG. 1).

The user may select a “create meal” option, the selection of which provides the user with a summary of their selected meal choices (block 364). Optionally, the user can select to print a shopping list associated with the items in the created meal, or print a list of locations of items within the meal that are located within the store. It should also be noted that the user may select a “go back” feature provided by the information suggestion system 2, to return to previous options and either change selections or review selections.

As has been mentioned above, the information suggestion system 2 of FIG. 1, may be adapted for use in industries besides the grocery industry. As an example, in accordance with a second exemplary embodiment of the invention, the information suggestion system 2 may be adapted for use in the home improvement industry. In addition, in accordance with a third exemplary embodiment of the invention, the information suggestion system 2 may be adapted for use in the automotive industry.

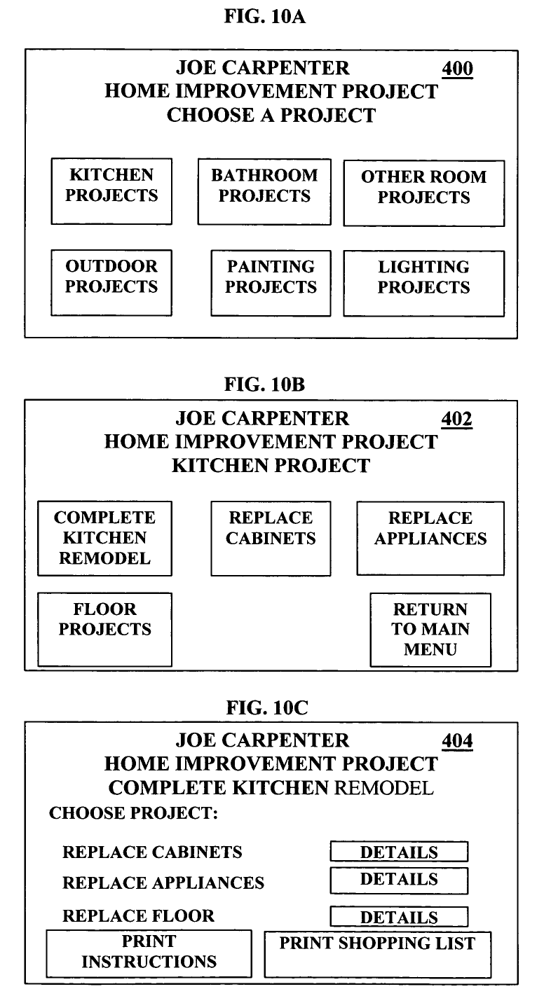

FIG. 10 illustrates a series of exemplary screen views used by the information suggestion system 2 to allow a user to perform a home improvement project. As with the menu suggestion example provided above, the accessing of information for the screen views may be defined by the software 10 (FIG. 1), although, as mentioned above, files defining titles and colors, among other things, are stored within the storage device 20 (FIG. 1).

FIG. 10A is an example of a first screen view 400 encountered by the user when using the information suggestion system 2 (FIG. 1), in accordance with the second exemplary embodiment of the invention. This screen view 400 allows the user to select a project among a series of home improvement projects. As an example, the user may select from “kitchen projects,” “bathroom projects,” “other room projects,” “outdoor projects,” “painting projects,” and “lighting projects.” Also, at any point during the process, the user can, alternatively, directly input a category of projects that he/she wants to perform by using the keyboard or touch screen. Information associated with the project may be stored within the storage device 20 (FIG. 1), so that when the user enters the project type via the keyboard or touch screen, a project associated with that project type, stored within the storage device 20 (FIG. 1), may be provided to the user via display on the touch screen. It should be noted that selection of the “other room projects” option may result in random selection of a room project from a series of room projects, descriptions of which may be stored within the storage device 20 (FIG. 1).

FIG. 10B is a new screen view 402 illustrating examples of choices that may be available to the user if he or she chooses to perform a kitchen project. As is shown by FIG. 10B, if the user selects to perform a kitchen project, the new screen view 402 provides the user with a series of choices of home improvement projects that may be performed on a kitchen. As an example, the new screen view 402 of FIG. 10B illustrates options for completing kitchen remodeling, replacing cabinets, replacing appliances, and floor projects. Of course, other choices may be provided. An option is also provided to return to the first screen view 400.

FIG. 10C is a result screen view 404 illustrating examples of specific projects that may be provided to a user if the complete kitchen remodel option is selected from the new screen view 402. As is shown by FIG. 10C, examples of such specific projects include, replacing cabinets, replacing appliances, and replacing the floor. It should be noted that an option to view steps, tools, and/or equipment necessary to complete a selected specific project may be viewed by selecting a details option associated with the specific project. In addition, options to print instructions required to perform the specific project may be provided. Further, an option to print a shopping list of tools, and/or equipment necessary to complete the selected specific project may be provided. An option may also be provided to view an estimated cost to complete the specific project and a time line.

As has been mentioned above, in accordance with a third exemplary embodiment of the invention, the present information suggestion system 2 (FIG. 1) may also be used to provide a suggestion as to automotive parts and instructions necessary for performing specific automotive repair services.

For example, if the user wants to replace belts in his truck, the information suggestion system 2 (FIG. 1) may provide instructions on how to replace each of the different belts, recommend belts and tools to use in the project, and/or recommend repair shops to replace the belts for the user. In accordance with the third exemplary embodiment on the invention, options may also be provided to view definitions or descriptions of terms common to the automotive industry. Options may also be provided to view locations of tools or parts in the store that are necessary for completing the specific automotive project.

As would be understood by one having ordinary skill in the art, database names and content stored within the databases differ in accordance with the category of goods or services accommodated for by the information suggestion system 2 (FIG. 1).

It should be emphasized that the above-described embodiments of the present invention are merely possible examples of implementations, merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

1. A method of electronically making suggestions to a user, where the suggestions are based on user input and store inventory, comprising the steps of:
determining what items are to be pushed from a store;
determining if items that are to be pushed from the store are physically located within the store; and
providing the user with a list of options, where each option includes at least one of the items that are to be pushed from the store, which are physically located within the store.

2. The method of claim 1, further comprising the step of determining what items are not to be pushed from the store and are physically located within the store, prior to the step of providing the user with the list of options, wherein the list of options includes an item from either the items that are to be pushed from the store, which are physically located within the store, or the items that are not to be pushed from the store, which are physically located within the store.

3. The method of claim 2, further comprising the steps of:
receiving a selected option from the user, wherein the selected option is one of the list of options provided to the user; and
providing the user with instructions required in completing an activity associated with the selected option.

4. The method of claim 3, where the selected option is a category of food and the instructions are for preparation of an entrée associated with the category of food.

5. The method of claim 4, further comprising the step of providing the user with a recipe required for preparation of the entrée.

6. The method of claim 3, wherein the step of providing the user with instructions further comprises a step selected from the group consisting of printing the instructions, downloading the instructions to an external device, displaying the instructions, and vocalizing the instructions.

7. The method of claim 3, further comprising the step of providing the user with location of each item within the selected choice.

8. The method of claim 3, further comprising the step of providing the user with a price of each item within the selected choice.

9. The method of claim 3, further comprising the step of providing the user with nutritional information about each item within the selected option.

10. The method of claim 3, wherein the step of receiving a selected option from the user further comprises receiving the selected option from a direct connection with a local input device.

11. The method of claim 3, wherein the step of receiving a selected option from the user further comprises receiving the selected option wirelessly from an external device.

12. The method of claim 3, wherein the step of receiving a selected option from the user further comprises receiving a voice command and interpreting the voice command.

13. The method of claim 3, wherein the step of receiving a selected option from the user further comprises receiving the selected option from the Internet.

14 The method of claim 1, further comprising the steps of:
determining what items are on sale at the store; and
determining if the items that are physically on sale are located within the store,
where the options also include the items that are on sale, which are physically located within the store.

15. The method of claim 1, wherein the steps of determining what items are to be pushed from the store, determining if items that are to be pushed from the store are physically located within the store, and providing the user with a list of options, where the options include the items that are to be pushed from the store, which are physically located within the store, are each performed electronically.

16. The method of claim 15, further comprising the step of electronically updating what items are physically located within the store.

17. The method of claim 1, wherein the options are related to a field selected from the group consisting of home improvement, grocery shopping, and automotive repair.

18. A method for suggesting a meal to a user, comprising the steps of:
providing the user with a list of options for creating the meal;
receiving one of the list of options from the user;
providing the user with a list of types of food associated with the received one of the list of options;
receiving a selected type of food from the user; and
providing the user with a list of entrees, where each entrée includes the selected type of food.

19. The method of claim 18, further comprising the steps of:
determining what items are to be pushed from a store; and
determining if items that are to be pushed from the store are physically located within the store,
where the list of options includes at least one of the items that are to be pushed from the store, which are physically located within the store, and
where the steps of determining what items are to be pushed from the store and determining if the items that are to be pushed from the store are physically located within the store, are both performed prior to the step of providing the user with a list of options for creating the meal.

20. The method of claim 19, further comprising the step of determining what items are not to be pushed from the store and are physically located within the store, prior to the step of providing the user with the list of options for creating the meal, where the list of options includes an item from either the items that are to be pushed from the store, which are physically located within the store, or the items that are not to be pushed from the store, which are physically located within the store.

21. A method for suggesting a home improvement project to a user, comprising the steps of:
determining what items are to be pushed from a store;
determining if items that are to be pushed from the store are physically located within the store; and
providing the user with a list of options for a home improvement project, where each option includes at least one of the items that are to be pushed from the store, and where each option is associated with a different location inside or outside of the home;
receiving one of the list of options from the user;
providing the user with a list of home improvement projects that may be performed, where each home improvement project in the list of home improvement projects is focused on the location in or outside of the home associated with the received one of the list of options;
receiving a selected home improvement project from the user; and
providing the user with a list of items necessary to complete the selected home improvement project.

22. The method of claim 21, further comprising the step of determining what items are not to be pushed from the store and are physically located within the store, prior to the step of providing the user with the list of options for a home improvement project, where the list of options includes at least one item from either the items that are to be pushed from the store, which are physically located within the store, or the items that are not to be pushed from the store, which are physically located within the store.

23. A system for making suggestions to a user, where the suggestions are based on user input and store inventory, the system comprising:
a memory; and
a processor configured by the memory to perform the steps of:
determining what items are to be pushed from a store;
determining if items that are to be pushed from the store are physically located within the store; and
providing the user with a list of options, where each option includes at least one of the items that are to be pushed from the store, which are physically located within the store.

24. The system of claim 23, wherein the processor is further configured by the memory to perform the function of determining what items are not to be pushed from the store and are physically located within the store, prior to the step of providing the user with the list of options, wherein the list of options includes an item from either the items that are to be pushed from the store, which are physically located within the store, or the items that are not to be pushed from the store, which are physically located within the store.

25. The system of claim 24, wherein the processor is further configured by the memory to perform the function of providing the user with instructions required in completing an activity associated with the selected option, after the system receives a selected option from the user, wherein the selected option is one of the list of options provided to the user.

26. The system of claim 25, wherein the selected option is provided by the user via use of a device selected from the group consisting of a touch screen monitor, a keyboard, a mouse, and a voice recognition device.
